(19) United States
(12) Patent Application Publication
(10) Pub. No.: US 2014/0315780 A1
(43) Pub. Date: Oct. 23, 2014

(54) PRODUCT

(71) Applicants: Jas Pal Singh BADYAL, Wolsingham (GB); Wayne Christopher Edward SCHOFIELD, Durham (GB); Suzanne MORSCH, Woodthorpe (GB)

(72) Inventors: Jas Pal Singh BADYAL, Wolsingham (GB); Wayne Christopher Edward SCHOFIELD, Durham (GB); Suzanne MORSCH, Woodthorpe (GB)

(21) Appl. No.: 14/323,440

(22) Filed: Jul. 3, 2014

Related U.S. Application Data
(63) Continuation of application No. 14/115,603, now abandoned.

(30) Foreign Application Priority Data
May 5, 2011 (GB) 1107494.5
Jul. 19, 2011 (GB) 1112404.7

(51) Int. Cl. C11B 9/00

(52) U.S. Cl. CPC C11B 9/0003
USPC 512/2

(57) ABSTRACT

A delivery system for an active substance, comprising a substrate on which the substance is loaded for subsequent release, wherein: (i) the substrate has been at least partially coated with a polymer using plasma deposition (preferably pulsed plasma deposition); (ii) the active substance is present as a guest molecule within a cyclodextrin inclusion complex; and (iii) the inclusion complex is bound to the polymer through a chemical linkage formed between a hydroxyl group on the cyclodextrin and a functional group on the polymer. The system may be used to control the release of an active substance such as a perfume. Also provided are methods for preparing (a) the delivery system and (b) a functionalised substrate for use as part of the system, in which the polymer is suitably reacted with a cyclodextrin using an S N 2 nucleophilic substitution reaction, in particular a Williamson ether synthesis reaction.

### FIELD OF THE INVENTION

This invention relates to active substance-loaded substrates and their preparation and use, and to functionalised substrates which can be loaded with active substances.

### BACKGROUND TO THE INVENTION

It is known to control the release of active substances by encapsulating them within entities such as microcapsules or micelles. In this way, release can be delayed until an appropriate future trigger, or allowed to proceed over an extended period of time, or otherwise controlled. The encapsulating entities can in some cases be immobilised on a solid substrate.

Active substances for which release might need to be controlled in this way include for example pharmaceuticals and fragrances.

Human sensory awareness of volatile fragrant molecules (or perfumes) is commonly associated with cleanliness and freshness for consumer products [1]. Indeed, perfume delivery systems which maintain the sensation of fragrance over extended periods of time are of interest to the smart textiles sector [2, 3].

Amongst the many different alternatives available (e.g. microcapsules [4], microparticles [5] and polymer micelles [6]), the dynamic release of perfumes by host-guest inclusion complexes is recognised as being highly promising [7]. This stems from the lack of strong binding interactions between the guest and host molecules (i.e. the hydrophobic effect and Van der Waals interactions) which influences release rates [8], whereas delivery from microcapsules or microparticles requires embedding within a matrix and physical or chemical triggers—for example external force, degradation over time, or pH change—to instigate perfume release [9, 10]. In the case of host-guest inclusion complexes, perfume release is accomplished through natural replacement of the guest molecules by other smaller molecules (usually water or small amines) from the surrounding environment [11].

Cyclodextrins are particularly well suited to host-guest inclusion complex interactions, because of their inherent cavity geometry. Their basic structure consists of cyclic oligosaccharides, with the most commonly available having six, seven or eight glucopyranose units (α-, β-, γ-cyclodextrin respectively). The oligosaccharide ring forms a torus or “barrel” shape, with the glucose unit primary hydroxyl groups present towards the narrow end, and the secondary hydroxyl groups located around the wider part [12]. A great variety of guest species are able to form inclusion complexes within the barrel cavity, leading to a range of surface-related applications including drug delivery control [13, 14, 15, 16], chromatography [17, 18], immobilisation of reactive chemicals [19, 20], solubility enhancement [21, 22], selective transport of compounds [23, 24] and perfume release [25, 26].

Such applications often require immobilisation of either the host or the guest molecules onto a solid surface, where the important prerequisites are appropriate surface orientation of the cyclodextrin “barrels”, ease of access for guest molecules into the barrel cavities, and a high density of attachment to the underlying surface. Previous attempts at forming oriented supported layers of cyclodextrins have included Langmuir-Blodgett films [27, 28], self-assembled monolayers (SAMs) of thiolated cyclodextrin derivatives on gold surfaces [29, 30, 31, 32] and chemisorption of cyclodextrin onto polymer supports [33, 34]. These approaches have experienced limited success due to their inherent complexities (for example the requirement for specific solid substrates), relatively low attachment densities, inherently low surface areas and/or inadequate functional retention capacities. There therefore exists a demand for improved selective release functional coatings which can be applied to a range of substrates.

Earlier studies have shown that an amine-functionalised variant of β-cyclodextrin, 6-amino-6-deoxy-β-cyclodextrin, can be successfully immobilised onto plasmachemical layers via reaction with the epoxide groups of pulsed plasma deposited poly(glycidyl methacrylate). The resultant cyclodextrin structures are capable of forming host-guest inclusion complexes with cholesterol (a bile acid) and N,N-dimethylformamide [35].

However, this process requires functionalisation of the cyclodextrin molecule before it can be bound to the polymer layer.

WO-2010/021973 describes a multi-layer controlled release system comprising a decomposable film on a substrate. The film has at least two differently charged polymeric layers, from which an active substance can be released by sequential degradation of the polymers in a suitable liquid medium. The layers must include a hydrolysable electrolyte, and also a “polymeric cyclodextrin”, i.e. a polymer either with a cyclodextrin backbone or with pendant cyclodextrin groups. The active substance is introduced into the cyclodextrin host molecules prior to deposition of the polymer layers, which can limit the techniques useable to deposit the polymers, in particular for sensitive active substances. Another drawback to this system is that active substance release requires degradation of the associated polymer layers, thus preventing its subsequent re-use.

Le Thuaut et al (Journal of Applied Polymer Science, vol 77: 2118-2125) describe the immobilisation of cyclodextrins on a nonwoven polypropylene support, for use in preparing “reactive filters”. Their technique involves graft-polymerisation of glycidyl methacrylate onto the support, followed by coupling of the polymer to α-, β- and γ-cyclodextrins via the epoxide groups.

It is an aim of the present invention to provide techniques for loading active substances, in particular volatile active substances such as perfumes, onto substrates for subsequent release. It is an aim to provide techniques which can overcome or at least mitigate the above described problems, and which can make efficient use of cyclodextrin inclusion complexes as hosts for active substance molecules.

### STATEMENTS OF THE INVENTION

According to a first aspect of the present invention there is provided a delivery system for an active substance, the system comprising a substrate on which the active substance is loaded for subsequent release, wherein:
(i) the substrate has been coated, over at least a part of its surface, with a polymer, using plasma deposition;
(ii) the active substance is present as a guest molecule within a cyclodextrin inclusion complex; and
(iii) the cyclodextrin inclusion complex is bound to the polymer through a chemical linkage formed between a hydroxyl group on the cyclodextrin and a functional group on the polymer.

Suitably, the cyclodextrin inclusion complex is exposed at a surface of the polymer coating, so as to facilitate release of the active substance from the inclusion complex without degradation or removal of the polymer.

By “delivery system”, in this context, is meant a system which is suitable for carrying an active substance, and subsequently delivering the active substance at or to a desired location.

In an embodiment, the chemical linkage is a direct chemical linkage, i.e. one which does not involve a linker group, for example a methacrylate such as glycidyl methacrylate, or a diisocyanate, between the hydroxyl group on the cyclodextrin and the functional group on the polymer. In an alternative embodiment, the chemical linkage involves the use of a suitable linking moiety between the hydroxyl group of the cyclodextrin and the functional group on the polymer, for instance as described below.

In an embodiment, the chemical linkage is formed between a primary hydroxyl group on the cyclodextrin and a functional group on the polymer. Suitably, it is formed between a hydroxyl group (in particular a primary hydroxyl group) on an underivatised cyclodextrin molecule.

In an embodiment, the chemical linkage is an ether linkage. It has been found that such ether linkages can be readily formed between hydroxyl groups (in particular primary hydroxyl groups) on cyclodextrin molecules and alkylating groups on polymer molecules, via a Williamson ether synthesis reaction. This is an S_{N}2 reaction which typically takes place between an alkoxide ion and an alkylating agent such as a primary alkyl halide. It can allow a cyclodextrin to be immobilised on a polymer-coated substrate by a simple in situ reaction with the polymer.

Further, because the ether synthesis reaction tends to take place at the primary hydroxyl groups (these being more nucleophilic and also having greater steric freedom than the secondary hydroxyl groups), it can help to orient the cyclodextrin molecules in a manner which enhances their ability to accept and release guest molecules, with the wider end of each “barrel” remote from the substrate and more accessible to the surrounding environment.

Other forms of chemical linkage may be usable. By way of example, a cyclodextrin hydroxyl group may be reacted with a linking moiety such as succinic anhydride, which may then be further reacted with a hydroxyl group present on the polymer, as when using a hydroxyl-substituted polymer such as poly(2-hydroxyethyl acrylate).

Other potential forms of chemical linkage include ester linkages (with acid or anhydride groups on the polymer); and alkyl or aryl sulphonate linkages (with for example sulphonyl halide groups on the polymer).

Once tethered to the polymer via the chemical linkage, the cyclodextrin may then be loaded with an active substance, to form a host-guest inclusion complex of known type. In this way the active substance (the “guest” molecule) can be captured on the substrate, but can subsequently be released from the cyclodextrin host molecules according to conventional release mechanisms. Such release can be easily achieved, in particular if the cyclodextrin host molecules are exposed at a surface of the polymer-coated substrate. There is typically no requirement for degradation or removal of the polymer, as in prior art systems such as that of WO-2010/021973, either to load the cyclodextrin molecule with the active substance or to release the active substance from the cyclodextrin. Similarly, once the active substance has been released, the cyclodextrin host molecule can be relatively easily reloaded with a further active substance, thus making the invented system reuseable.

Cyclodextrin inclusion complexes formed in this way have been found to allow extended release of the guest molecules. By “extended release” is meant release which continues to occur over a period of time following loading of the complex with the guest molecule (the active substance), for example for 30 or more days, or for 60 or more days, or for 70 or 80 or more days, or in cases for 3 or 5 or even 8 or more months. Such release may for example continue for up to 10 months or for up to 9 or 8 or 7 months. As discussed above, the release will typically occur through replacement of the guest molecules by other, typically smaller, molecules from the surrounding environment. Other forms of release may however be possible, as described in more detail below.

The present invention can thus make possible the gradual release of an active substance from a substrate, which can have a wide range of applications. In effect, the invention can provide a polymeric coating on a substrate, which is functionalised to allow the loading, and subsequent release, of an active substance.

In a delivery system according to the invention, the substrate may be formed of any suitable material (typically a solid), depending on its intended use. In an embodiment, the substrate is selected from textile materials (made from either woven or non-woven, natural or synthetic, fibres); metal; glass; ceramics; semiconductors; cellulosic materials; paper and card; wood; structural polymers such as polytetrafluoroethylene, polyethylene, polypropylene and polystyrene; and combinations thereof. In an embodiment, the substrate is a textile material (either woven or non-woven). It may be any object to which an active substance-releasing coating is to be applied, including a thin substrate or film which is itself suitable and/or adapted and/or intended to be applied to the surface of another object.

In an embodiment, the substrate comprises an open structure, for example a network of fibres, which can serve as a scaffold for the cyclodextrin-derivatised polymer coating.

The polymer is applied to the substrate by plasma deposition. Plasma (or plasmachemical) deposition processes are well known in the art and involve the deposition of a monomer (polymer precursor) onto a substrate within an exciting medium such as a plasma, which causes the precursor molecules to polymerise as they are deposited. Plasma-activated polymer deposition processes have been widely documented in the past—see for example J P S Badyal, Chemistry in Britain 37 (2001): 45-46.

A plasma deposition process may be carried out in the gas phase, typically under sub-atmospheric conditions, or on a liquid monomer or monomer-carrying vehicle as described in WO-03/101621.

In an embodiment, the polymer is applied to the substrate using a pulsed plasma deposition process. In an embodiment, it is applied using an atomised liquid spray plasma deposition process, in which, again, the plasma may be pulsed.

A pulsed electrical discharge can result in structurally well-defined coatings. Mechanistically, it entails the generation of active sites—predominantly radicals—in the monomer phase within the electrical discharge, and also at the growing polymer film surface, during the short duty cycle on-period (typically microseconds). This is followed by conventional polymerisation mechanisms proceeding throughout the relatively long (typically milliseconds) duty cycle off-period, in the absence of any UV-, ion-, or electron-induced damage.

The advantages of using (pulsed) plasma deposition can include its potential applicability to a wide range of substrate materials and geometries, with the resulting deposited layer conforming well to the underlying surface. The technique can provide a straightforward and effective method for functionalising solid surfaces, being a single step, solventless and substrate-independent process. The inherent reactive nature of the electrical discharge can ensure good adhesion to the substrate via free radical sites created at the interface during ignition of the plasma. Moreover during pulsed plasma deposition, the level of surface functionality can be tailored by simply pre-programming the plasma duty cycle.

Well defined functional films containing anhydride [36], carboxylic acid [37], cyano [38], epoxide [39], hydroxyl [40], furfuryl [41], thiol [42], amine [43], perfluoroalkyl [44], perfluoromethylene [45] and trifluoromethyl [46] groups have been successfully prepared in the past using pulsed plasma deposition techniques, also aldehyde groups [McGettrick, J D; Schofield, W C E; Garrod, R P; Badyal, J P S, Chem Vap Deposition 2009, 15: 122]; halide groups [Teare, D O H; Barwick, D C; Schofield, W C E; Garrod, R P; Ward, L J; Badyal, J P S, Langmuir, 2005, 21: 11425; R P Garrod; L G Harris; W C E Schofield; J McGettrick; L J Ward; D O H Teare; J P S Badyal, Langmuir, 2007, 23: 689; McGettrick, J D; Crockford, T; Schofield, W C E; Badyal, J P S, Appl Surf Sci, 2009, 256: S30]; ester groups [Teare, D O H; Schofield, W C E Garrod, R P; Badyal, J P S, J Phys Chem B, 2005, 109: 20923]; and pyridine groups [Bradley, T J; Schofield, W C E; Garrod, R P; Badyal, J P S, Langmuir 2006, 22: 7552; Schofield, W C E; Badyal, J P S, ACS Applied Materials and Interfaces, 2009, 1: 2763]. Other previous examples of pulsed plasma deposited functional films include poly(glycidyl methacrylate), poly(bromoethyl-acrylate), poly(vinyl aniline), poly(vinylbenzyl chloride), poly(allylmercaptan), poly(N-acryloylsarcosine methyl ester), poly(4-vinyl pyridine) and poly(hydroxyethyl methacrylate).

Any suitable conditions may be employed for the plasma deposition of the polymer onto the substrate, depending on the nature of the monomer and of the coating needed on the substrate. By way of example, and in particular when using a pulsed plasma and/or when the polymer is a polyvinyl polymer such as a poly(vinylbenzyl halide), one or more of the following conditions may be used:
a. a pressure of from 0.1 to 1 mbar, or from 0.1 to 0.5 mbar, such as about 0.2 mbar.
b. a temperature of from 5 to 50° C., or from 10 to 30° C., such as room temperature (which may be from about 18 to 25° C., such as about 20° C.).
c. a power (or in the case of a pulsed plasma, a peak power) of from 10 to 70 W, or from 20 to 50 W, such as about 30 or 40 W.
d. in the case of a pulsed plasma, a duty cycle on-period of from 10 to 200 μs, or from 50 to 150 μs, such as about 100 μs.
e. in the case of a pulsed plasma, a duty cycle off-period of from 0.5 to 20 ms, or from 1 to 10 ms, or from 1 to 5 ms, such as about 4 ms.
f. in the case of a pulsed plasma, a ratio of duty cycle on-period to off-period of from 0.001 to 0.05, or from 0.01 to 0.05, such as about 0.025.

A polymer which has been applied to a substrate using plasma deposition will typically exhibit good adhesion to the substrate surface. The applied polymer will typically form as a uniform conformal coating over the entire area of the substrate which is exposed to the relevant monomer during the deposition process, regardless of substrate geometry or surface morphology. Such a polymer will also typically exhibit a high level of structural retention of the relevant monomer, particularly when the polymer has been deposited at relatively high flow rates and/or low average powers such as can be achieved using pulsed plasma deposition or atomised liquid spray plasma deposition.

Suitably, in a delivery system according to the invention, the cyclodextrin molecule is bound to the polymer coating at the exposed surface of the coating. The polymer may be applied to the substrate in the form of a single coating layer. The polymer coating may have any appropriate thickness. It may for example have a thickness of 1 nm or greater, or of 10 or 50 nm or greater, or of 75 or 100 nm or greater, or in cases of 0.5 or 1 or 10 μm or greater. This thickness may be up to 100 μm, or up to 10 or 1 μm, or up to 500 or 200 nm. It may for example be from 1 nm to 100 μm, or from 50 to 500 nm, or from 50 to 200 nm, or from 75 to 200 nm or from 100 to 200 nm.

The cyclodextrin-derivatised polymer may contain one or more pores, in particular macropores: in such a case, a cyclodextrin inclusion complex may be exposed at an internal surface of a pore. A porous cyclodextrin-derivatised polymer layer may display a gradient in porosity which decreases from the outer surface towards the substrate interface, to help increase mass transport of guest molecules. In particular, it may have smaller pores at and close to the substrate-polymer interface than at the external polymer surface.

A (macro)porous structure may be achieved by inducing the formation of a water-in-oil emulsion within the cyclodextrin-derivatised polymer layer. This has been found to be possible without the need for additional emulsion stabilising agents such as surfactants, provided the overall derivatised polymer system is amphiphilic in nature (i.e. incorporates both hydrophilic and hydrophobic entities, for example the hydrophilic pendant cyclodextrin molecules linked to a hydrophobic polymer such as a poly(vinylbenzyl) polymer). Indeed, in such systems, spontaneous emulsification can occur during the formation of the polymer-cyclodextrin linkages, and can result in a macroporous polyHIPE (high internal phase emulsion) structure in which pendant β-cyclodextrin groups are present at exposed surfaces both inside the pores and at the external polymer surface.

In an embodiment, such a porous system comprises a three-level hierarchical porous structure, incorporating nanoporosity (the cyclodextrin cavities) supported on a polyHIPE structure (with pore diameters typically of the order of several μm), which in turn is fixed onto an open substrate scaffold, such as a network of fibres with interfibre spacings of the order of several hundred μm.

In order for such emulsification to occur, it may be necessary for the deposited polymer coating to have a certain minimum thickness, for example of 150 nm or greater.

The ability to form cyclodextrin-derivatised porous polymer coatings, in accordance with the invention, can bring significant benefits. It can combine the inherent advantages of plasmachemical functionalisation (which is a substrate-independent, solventless, single-step deposition process) with the spontaneous, stabiliser-free emulsification of the β-cyclodextrin-derivatised polymer layer. As a result, there exists the potential to apply this hierarchical macro- to nanoporous structure methodology to other high surface area substrates. High surface area (macro)porous polymers can be difficult and/or expensive to make. Conventional polyHIPEs are foamed by template polymerisation around the aqueous phase of a water-in-oil emulsion, which needs to be stabilised using an appropriate surfactant. In contrast, the present invention can provide a relatively simple and cheap route to cyclodextrin-derivatised polyHIPE structures, which can function as high loading capacity active substance capture and/or release systems.

The term “polymer”, in the context of the present invention, also embraces a copolymer. In accordance with the invention, the polymer should comprise a substituent (i.e. a functional group such as an acid, aldehyde or alkyl halide) which is capable of reacting with a hydroxyl group on the cyclodextrin molecule (or with a derivative of such a group, for example an alkoxide ion) in order to generate the required chemical linkage. In an embodiment, the polymer comprises an alkylating group capable of reacting with the cyclodextrin hydroxyl group or derivative under appropriate conditions, for instance via a Williamson ether synthesis reaction. The alkylating group suitably includes a leaving group which may be displaced by a nucleophile, such as an alkoxide ion, formed from the cyclodextrin hydroxyl group. In an embodiment, the leaving group is a halide, for example chloride. The polymer may thus be a halogenated, in particular chlorinated, polymer. Its alkylating group is suitably a primary alkyl or aryl-alkyl halide, including for instance a benzyl halide.

In a specific embodiment of the invention, the polymer is a vinyl polymer, in particular a halogenated vinyl polymer. In an embodiment, the polymer is a poly(vinylbenzyl halide), for example a poly(4-vinylbenzyl chloride).

In another specific embodiment, the polymer is a hydroxyl-substituted polymer such as a hydroxyl-substituted acrylate, for example poly(2-hydroxyethyl acrylate).

In an embodiment, at least 40% of the relevant functional groups on the polymer are bound to cyclodextrin molecules through chemical linkages. In an embodiment, at least 50% of the relevant functional groups are so bound, or in cases at least 60%. It is possible, using the present invention, to achieve relatively high polymer-cyclodextrin attachment densities, and hence relatively high active substance-carrying capacities, on a substrate surface, for instance compared to those achievable using prior art cyclodextrin-based delivery systems.

The active substance may be any substance which it is desired to carry on the substrate for subsequent release and which is capable of being held as a guest molecule within a cyclodextrin inclusion complex. It may for example comprise a substance selected from pharmaceutically active substances (including antimicrobial agents such as antibacterial or antifungal agents); flavourings; perfumes; dyes; cosmetics; and mixtures thereof. In an embodiment, it comprises a volatile substance such as a perfume.

In an embodiment, the active substance comprises a lipophilic substance, or a substance having one or more lipophilic substituents. This can help improve its uptake into the host cyclodextrin molecule, as discussed in more detail below. In an embodiment, the active substance comprises an essential oil (also known as a volatile oil, an ethereal oil or an aetherolea). In an embodiment, it comprises an essential oil selected from lavender, sandalwood, jasmine, rosemary, lemon, vanilla and mixtures thereof; or from sandalwood, jasmine, rosemary, vanilla and mixtures thereof; or from sandalwood, rosemary, vanilla and mixtures thereof; or from jasmine, rosemary, vanilla and mixtures thereof; or from rosemary, vanilla and mixtures thereof.

In an embodiment, the active substance comprises an aromatic compound, i.e. a compound containing one or more aromatic (for example phenyl) rings.

The cyclodextrin used in the present invention may be selected from α-, β- and γ-cyclodextrins and mixtures thereof. In an embodiment, it is a β-cyclodextrin.

According to a second aspect, the present invention provides a method for preparing a functionalised substrate on which an active substance can be loaded for subsequent release, the method comprising:
(i) providing a substrate which has been coated, over at least a part of its surface, with a polymer, using plasma deposition; and
(ii) reacting the polymer with a cyclodextrin molecule so as to generate a chemical linkage between a hydroxyl group on the cyclodextrin molecule and a functional group on the polymer.

The reaction is suitably such that the cyclodextrin molecule is then exposed at a surface of the polymer coating, so as to facilitate loading of an active substance into, and/or release of an active substance from, the cyclodextrin molecule without degradation or removal of the polymer.

Again, the chemical linkage may be a direct chemical linkage. It may be an ether linkage. It may be formed between a primary hydroxyl group on the cyclodextrin and a functional group on the polymer.

The reaction step (ii) may be an S_{N}2 nucleophilic substitution reaction. In an embodiment, it is a Williamson ether synthesis reaction. Such a reaction is suitably carried out under basic conditions, for example in the presence of a base such as sodium or potassium hydroxide, or sodium (bi)carbonate, in order to convert hydroxyl groups on the cyclodextrin into alkoxide ions. The reaction may be carried out in solution, for example in aqueous solution. Suitable solvents, temperatures and reaction times—and catalysts if appropriate—will naturally depend on the nature of the polymer.

In an embodiment, the reaction is allowed to proceed until at least 40% of the relevant functional groups on the polymer are bound to cyclodextrin molecules through the chemical linkages, or at least 50 or 60%. In an embodiment, the reaction is allowed to proceed until the polymer surface is saturated with chemically-linked cyclodextrin molecules, or at least 98 or 95 or 90 or 80 or 70% saturated.

The method of the second aspect of the invention may also comprise applying the polymer to the substrate prior to the reaction step (ii). As described above, this may involve the use of a pulsed plasma deposition process.

The method may comprise loading the cyclodextrin with an active substance following the reaction step (ii), so as to generate a cyclodextrin inclusion complex, attached to the polymer, containing an active substance guest molecule. The loading step may be carried out by any suitable means, for example by immersing the substrate in the active substance, or in a solution or dispersion of the active substance, or by washing the polymer coating with the active substance or a solution or dispersion thereof. Such a method may be used to prepare an active substance-loaded delivery system in accordance with the first aspect of the invention.

The functionalised substrate may be loaded with a further quantity of the, or another, active substance in a similar fashion. Thus, once a certain amount of the active substance has been released from the cyclodextrin host molecules, the substrate may effectively be “recharged” with more of the same active substance and/or with another active substance.

A third aspect of the invention provides a functionalised substrate for use as part of a delivery system according to the first aspect, and/or which has been prepared according to the method of the second aspect, which substrate has been coated, over at least a part of its surface, with a polymer, using plasma deposition, and in which the polymer is bound to a cyclodextrin molecule via a chemical linkage (in particular an ether linkage) formed between a hydroxyl group on the cyclodextrin and a functional group on the polymer. Again the cyclodextrin molecule is suitably exposed at a surface of the polymer coating, so as to facilitate loading of an active substance into, and/or release of an active substance from, the cyclodextrin molecule without degradation or removal of the polymer.

In an embodiment, such a functionalised substrate may be used to “capture” an active substance from an environment. The active substance may be captured as a guest molecule within the cyclodextrin molecule. Such a substance may be removed from the environment, within the cyclodextrin molecule, and subsequently, if appropriate, released therefrom, following which the functionalised substrate may be reused to capture another active substance.

A fourth aspect of the invention provides a method for capturing a first active substance from a first environment containing it, the method comprising introducing into the first environment a functionalised substrate according to the third aspect of the invention, and allowing the first active substance to enter a cyclodextrin molecule as a guest molecule.

The invention can thus be used to remove an active substance from an environment containing it.

The method of the fourth aspect of the invention may comprise subsequently releasing the first active substance, or at least a portion thereof, from the cyclodextrin host molecule.

An active substance may be released from a cyclodextrin host molecule (i.e. from a cyclodextrin inclusion complex) by any suitable means. In an embodiment, the active substance may be extracted into a suitable solvent system, for example by washing the functionalised substrate or delivery system with the solvent system. In an embodiment, the active substance may be released by modifying it in some way, such that the modified form of the substance is less well suited (for example energetically and/or sterically suited) to reside within the cyclodextrin host molecule: such a modification may for example be achieved by changing the pH of the environment to which the active substance is exposed. In an embodiment, the active substance may be replaced by a competitor molecule which is better suited to occupying the cyclodextrin host molecule: such a competitor molecule may for example be water, for instance atmospheric moisture, and may suitably be smaller than the active substance.

The key factors that underpin host-guest inclusion complex formation (“capture”) relate to thermodynamic interactions between the various constituents (i.e. β-cyclodextrin, guest, and solvent), which give rise to a net energetic driving force which compels the guest molecule to dock into the cyclodextrin cavity. If this driving force can be overcome, then release and/or substitution of the guest molecule can be achieved. For most guest molecules, the ionised or charged form of the molecule will exhibit poorer binding to cyclodextrins compared to the non-ionised or neutral form of the molecule (i.e. where the pH of the surrounding medium is greater than the pKₐ of the molecule).

Such release mechanisms may also be used to facilitate release of an active substance from a delivery system according to the first aspect of the invention.

A method according to the fourth aspect of the invention may comprise subsequently re-using the functionalised substrate, following release of the first active substance, in order to capture a second active substance (which may be the same as, or different to, the first active substance) from a second environment which contains the second active substance. The second environment may be the same as, or different to, the first environment. In this way the functionalised substrate may be used and re-used any number of times, as desired.

According to a fifth aspect of the invention, there is provided a method for preparing an active substance delivery system (for example a system according to the first aspect of the invention), the method comprising loading an active substance onto a functionalised substrate according to the third aspect, so as to generate an active substance-containing cyclodextrin inclusion complex attached to the polymer. This method may also be used to “recharge” a functionalised substrate or delivery system, as described above.

A sixth aspect of the invention provides a product which is formed from or incorporates (a) a delivery system according to the first aspect, (b) a functionalised substrate according to the third aspect, and/or (c) a functionalised substrate (optionally loaded with an active substance) which has been produced using a method according to the second, fourth or fifth aspect. The product may be for example a garment, an item of footwear or a personal accessory (including an item of jewelry). It may be an item of furniture (including a car seat), or of soft furnishing (for example a curtain, or a wall or floor covering). It may be a household product such as an air freshener or laundry treatment product. It may be a cosmetic or toiletry product; a dressing or sanitary product; or a deodorant product, including for example a shoe insert such as an insole. It may be an item of packaging, for example food packaging. It may be a scaffold structure for use in tissue engineering. The product may incorporate one or more additional active substances such as antimicrobial (including antifungal), deodorant or anti-perspirant agents.

In certain embodiments of the invention, the active substance may be loaded into any suitable host molecule, in particular a cavitand such as a cyclodextrin. The host molecule may be bound to the polymer through a chemical linkage formed between a functional group (in particular a hydroxyl group) on the host molecule and a functional group on the polymer. The linkage may be a direct chemical linkage; it may be an ether linkage.

A delivery system, functionalised substrate or method according to the invention may be used for the purpose of controlling (in particular extending) the release of an active substance from a substrate. It may be used for the purpose of capturing an active substance from an environment which contains the substance.

Throughout the description and claims of this specification, the words “comprise” and “contain” and variations of the words, for example “comprising” and “comprises”, mean “including but not limited to”, and do not exclude other moieties, additives, components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Other features of the invention will become apparent from the following examples. Generally speaking the invention extends to any novel one, or any novel combination, of the features disclosed in this specification (including any accompanying claims and drawings). Thus features, integers, characteristics, compounds, chemical moieties or groups described in conjunction with a particular aspect, embodiment or example of the invention are to be understood to be applicable to any other aspect, embodiment or example described herein unless incompatible therewith. Moreover unless stated otherwise, any feature disclosed herein may be replaced by an alternative feature serving the same or a similar purpose.

Where upper and lower limits are quoted for a property, for example for the concentration of a component or a temperature, then a range of values defined by a combination of any of the upper limits with any of the lower limits may also be implied.

The present invention will now be further described with reference to the following non-limiting examples and the accompanying figures, of which:

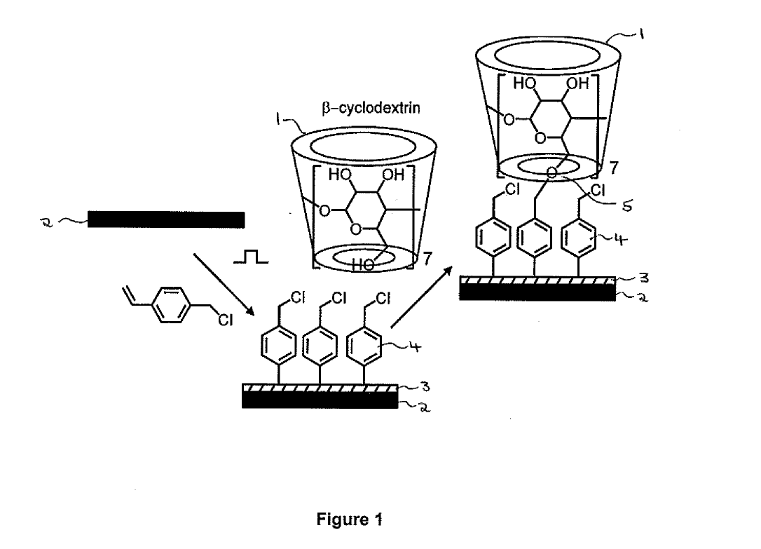

FIG. 1 shows schematically a method in accordance with the invention;

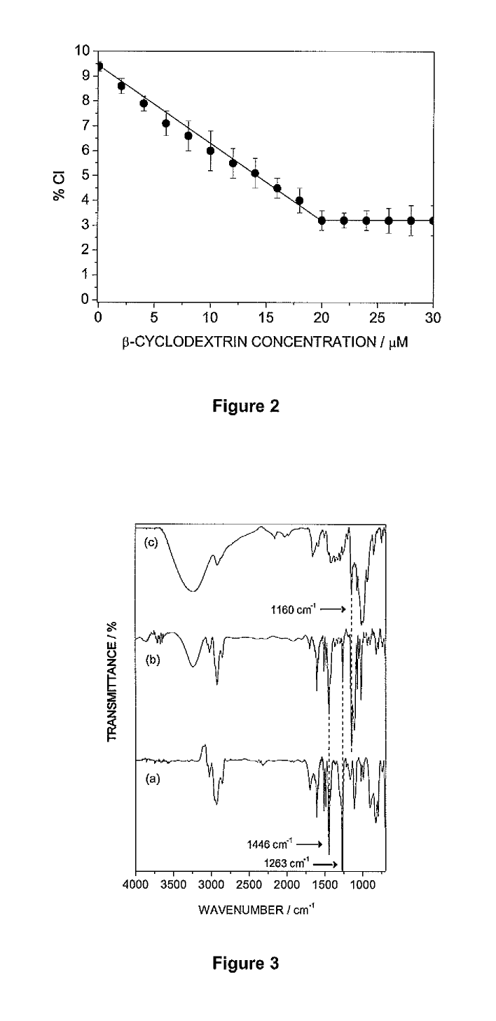

FIG. 2 is a graph showing the variation of polymer surface chlorine concentration (by X-ray photoelectron spectroscopy) with β-cyclodextrin solution concentration, following reaction of a surface polymer layer with a β-cyclodextrin solution in Example 1 below;

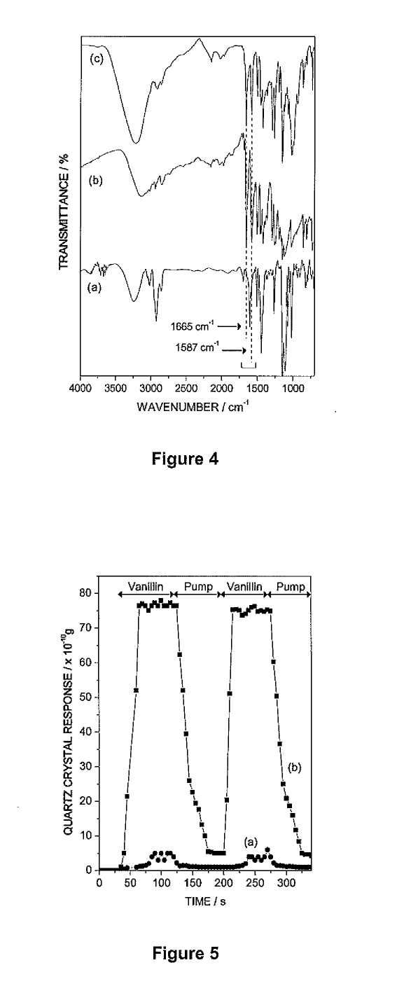

FIGS. 3 and 4 show infrared spectra for materials used and produced in Example 1;

FIG. 5 shows quartz crystal microbalance measurements taken during vanillin exposure to cyclodextrin-derivatised and underivatised polymer layers produced in Example 1;

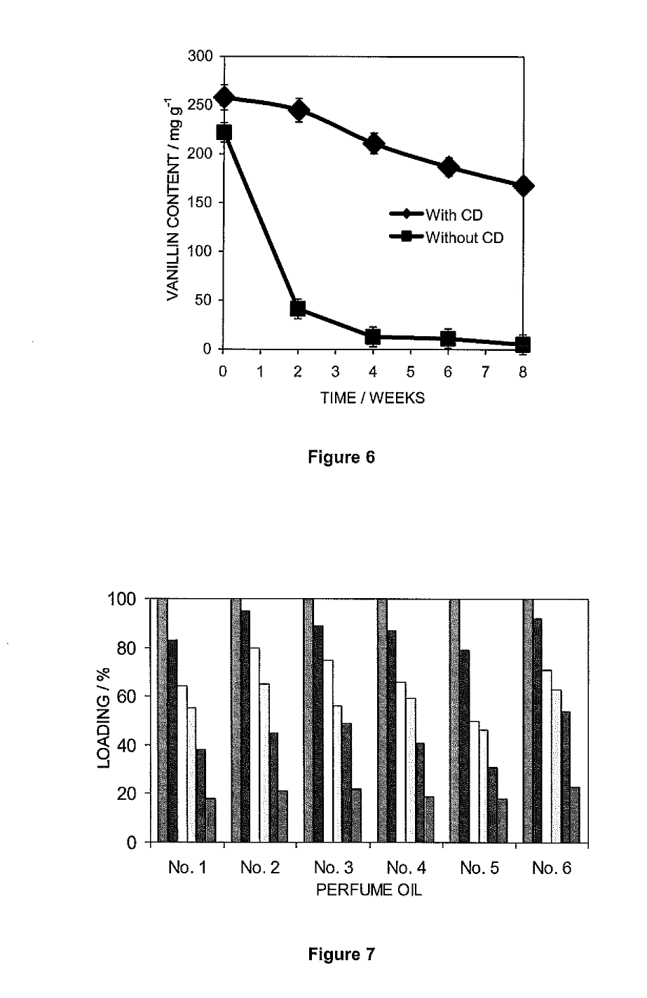

FIG. 6 shows vanillin release rates from cyclodextrin-derivatised and underivatised polymer layers produced in Example 1; and

FIG. 7 shows essential oil loadings in derivatised polymer layers produced in Example 2, and their rates of change during subsequent storage.

### DETAILED DESCRIPTION

### the FIG. 1 Scheme

FIG. 1 shows how, in accordance with the invention, a β-cyclodextrin “barrel” 1 can be tethered to a substrate 2 via an intermediate polymer layer 3.

Firstly, a thin polymer layer is deposited on the substrate using for instance a pulsed plasma deposition technique. The polymer in this case is poly(4-vinylbenzyl chloride), which on the surface of the substrate presents pendent benzyl chloride groups 4.

The polymer layer is then reacted with the β-cyclodextrin in the presence of a base such as a hydroxide. The base converts the primary hydroxyl groups on the cyclodextrin into alkoxide ions, in situ, and the alkoxide ions then undergo the Williamson ether synthesis reaction with the benzyl chloride groups on the polymer, displacing the chlorines to form ether linkages as shown at 5 [47].

The thus-immobilised cyclodextrin barrels may then be loaded with an active substance such as a perfume (not shown in FIG. 1), for subsequent release.

In contrast to the earlier utilisation of 6-amino-6-deoxy-β-cyclodextrin barrels for tethering to pulsed plasma deposited poly(glycidyl methacrylate), the approach provided by the present invention allows the use of unmodified cyclodextrins as immobilised carriers for active substances.

FIG. 1 shows schematically how the cyclodextrin molecule adopts the approximate shape of an axially extended torus or hollow frustocone. The narrower end of the molecule is oriented towards the polymer surface through the ether linkages with the polymer benzyl groups. The wider end is remote from the surface, and so is better able to accept and release guest molecules. Thus, the ether synthesis reaction—together with the inherent steric flexibility of the polymer layer 3—helps to orientate the cyclodextrin complex appropriately, with the axis of the frustocone approximately perpendicular to the polymer/substrate surface.

In the examples below, substrates prepared as shown in FIG. 1 were loaded with perfumes. The guest-host interactions between the perfume molecules and the immobilised β-cyclodextrin barrels were characterised by infrared spectroscopy, quartz crystal microbalance (QCM) and human sensory testing, demonstrating extended release of the perfumes from the cyclodextrin inclusion complexes.

### Example 1

### 1 Experimental

Pulsed plasma deposition of 4-vinylbenzyl chloride (+98%, Aldrich, purified using several freeze-pump-thaw cycles) was carried out in an electrodeless cylindrical glass reactor (5 cm diameter, 520 cm³ volume, base pressure of 1×10⁻³ mbar, and with a leak rate better than 1.8×10⁻⁹ kg s⁻¹) enclosed in a Faraday cage. The chamber was fitted with a gas inlet, a Pirani pressure gauge, a 30 L min⁻¹ two-stage rotary pump attached to a liquid cold trap, and an externally wound copper coil (4 mm diameter, 9 turns, spanning 8-15 cm from the precursor inlet). All joints were grease free.

An L-C network was used to match the output impedance of a 13.56 MHz radio frequency (RF) power generator to the partially ionised gas load. The RF power supply was triggered by a signal generator and the pulse shape monitored with an oscilloscope. Prior to each experiment, the reactor chamber was cleaned by scrubbing with detergent and rinsing in water and propan-2-ol, followed by oven drying. The system was then reassembled and evacuated. Further cleaning consisted of running an air plasma at 0.2 mbar pressure and 50 W power for 30 minutes.

Next a polished silicon (100) wafer (MEMC Electronics Materials, cleaned ultrasonically in a 50/50 propan-2-ol/cyclohexane solvent mixture), or non-woven polypropylene cloth (Corovin GmbH) was inserted into the centre of the reactor, and the chamber pumped back down to base pressure. At this stage, 4-vinylbenzyl chloride monomer vapour was introduced at a pressure of 0.2 mbar for 5 minutes prior to ignition of the electrical discharge. The optimum conditions for functional group retention corresponded to a peak power of 40 W, and a duty cycle on-time of 100 μs and off-time of 4 ms. Deposition was allowed to proceed for 10 minutes to yield 150±5 mm thick layers. Upon plasma extinction, the precursor vapour continued to pass through the system for a further 3 minutes, and then the chamber was evacuated back down to base pressure.

Surface derivatisation of the pulsed plasma deposited poly(4-vinylbenzyl chloride) layers with β-cyclodextrin (Fluka Chemicals) entailed immersion of the coated substrate in various β-cyclodextrin solutions (5-40 μM) in 25 μM sodium hydroxide. This gave rise to a range of surface packing densities. After incubation for 72 hours at room temperature (approximately 20° C.), the samples were thoroughly rinsed in high purity water, ethanol and propan-2-ol to remove any unbound β-cyclodextrin and reconvert any unused alkoxide groups back to primary alcohol groups.

Inclusion complexes between guest vanillin (4-hydroxy-3-methoxybenzaldehyde, Aldrich) molecules with the surface derivatised β-cyclodextrin were prepared by immersion in a 75 mM ethanolic vanillin solution for periods of up to 72 hours. Subsequent washing with ethanol and propan-2-ol, followed by drying in an oven at 35° C. for 60 minutes, removed any unbound guest molecules.

Film thickness measurements were carried out using an nkd-6000 spectrophotometer (Aquila Instruments Ltd). The acquired transmittance-reflectance curves (350-1000 nm wavelength range) were fitted to a Cauchy model for dielectric materials employing a modified Levenberg-Marquardt method [48]. X-ray photoelectron spectroscopy (XPS) analysis of the layers was undertaken on a VG ESCALAB instrument equipped with an unmonochromated Mg Kα X-ray source (1253.6 eV) and a hemispherical analyser operating in the constant analyser energy mode (CAE, pass energy=20 eV). XPS core level spectra were fitted using Marquardt minimisation software assuming a linear background and equal full-width-at-half-maximum (fwhm) Gaussian component peaks [49]. Elemental concentrations were calculated using instrument sensitivity (multiplication) factors determined from chemical standards, C(1s): O(1s): Cl(2p)=1.00: 0.45: 0.38. The absence of any Si(2p) signal from the underlying substrate was taken as being indicative of pin-hole free layer coverage at a thickness exceeding the XPS sampling depth (2-5 nm) [50, 51].

Fourier transform infrared (FTIR) analysis of the layers at each stage of reaction was carried out using a Perkin-Elmer Spectrum One spectrometer equipped with a liquid nitrogen cooled MCT detector operating across the 700-4000 cm⁻¹ wavenumber range. Reflection-absorption (RAIRS) measurements were performed using a variable angle accessory (Specac Inc) set at 66° with a KRS-5 polariser fitted to remove the s-polarised component. All spectra were averaged over 5000 scans at a resolution of 4 cm⁻¹.

Real-time guest-host interactions were followed by exposure of vanillin vapour at 0.2 mbar pressure for 345 seconds to a quartz crystal detector (Varian model 985-7013 using a 5 MHz AT-cut quartz 13 mm diameter crystal) which had been coated with pulsed plasma deposited poly(4-vinylbenzyl chloride), both with and without 20 μM β-cyclodextrin functionalisation. Mass readings were taken every 5 seconds during exposure and for 60 seconds thereafter.

### 2 Results

### 2.1 Surface Immobilisation of β-Cyclodextrin

XPS analysis of the pulsed plasma deposited poly(4-vinylbenzyl chloride) layers confirmed the presence of carbon and chlorine at the surface (see Table 1 below). Following reaction with β-cyclodextrin, there is the appearance of an O(1s) peak and accompanying attenuation of the Cl(2p) peak.

TABLE 1
(XPS atomic percentages)

| | Elemental (%) | | |
|---|---|---|---|
| Sample | % C | % O | % Cl |
| Theoretical poly(4-vinylbenzyl | 90.0 | — | 10.0 |
| chloride) | | | |
| Pulsed plasma poly(4-vinylbenzyl | 90.6 ± 0.1 | — | 9.4 ± 0.1 |
| chloride) | | | |
| Theoretical β-cyclodextrin | 54.5 | 45.5 | — |
| monolayer | | | |
| Pulsed plasma poly (4-vinylbenzyl | 65.4 ± 0.1 | 31.4 ± 0.1 | 3.2 ± 0.5 |
| chloride)/β-cyclodextrin (20 μM) | | | |

It was found that the surface packing density of the tethered β-cyclodextrin barrels could be controlled by varying the reaction conditions. FIG. 2 shows the XPS chlorine concentration (% Cl) at the surface of the polymer layer, following reaction with β-cyclodextrin, as a function of solution concentration: it can be seen that β-cyclodextrin solution concentrations of 20 μM and higher yielded surface saturation, whilst lower dilutions yielded sub-monolayer coverages.

Table 1 and FIG. 2 together show that at higher β-cyclodextrin solution concentrations, there was at least 66% derivatisation of the available surface chlorine groups in the deposited polymer layer.

FIG. 3 shows the infrared spectra taken of the pulsed plasma deposited poly(4-vinylbenzyl chloride) layers. Trace (a) is for the polymer layer (Pₚ=40 W; tₒₙ=100 μs; t_{off}=4 ms; 10 minutes); (b) is for the polymer layer reacted with a 20 μM solution of β-cyclodextrin (Pₚ=40 W; tₒₙ=100 μs; t_{off}=4 ms; 10 minutes); and (c) is for the β-cyclodextrin.

The spectra were assigned as follows [53]: 1263 cm⁻¹ halide functionality (CH₂wag mode for CH₂—Cl), 1446 cm⁻¹ polymer backbone CH₂ scissoring stretch, and parasubstituted phenyl ring stretches at 1495 cm⁻¹ and 1603 cm⁻¹. In addition, compared to the precursor, the absence of the vinyl double bond stretch at 1629 cm⁻¹ is consistent with the monomer having undergone polymerisation.

Derivatisation of the pulsed plasma deposited poly(4-vinylbenzyl chloride) layer with β-cyclodextrin gave rise to the appearance of several new infrared bands [54] at 754 cm⁻¹, 1045 cm⁻¹, 1085 cm⁻¹ and 1160 cm⁻¹, which are all associated with β-cyclodextrin. The poly(4-vinylbenzyl chloride) CH₂—Cl absorbance at 1263 cm⁻¹ was noted to have significantly dropped in intensity with respect to the polymer backbone peak at 1446 cm⁻¹ following the Williamson ether synthesis reaction. Any remaining CH₂—Cl groups detected following surface tethering correspond to either unreacted CH₂—Cl groups at the surface (not all primary hydroxyl centres on the β-cyclodextrin barrel need attach to the surface for successful binding) or they are located within the subsurface region of the pulsed plasma deposited poly(4-vinylbenzyl chloride) layer. Also O—H stretching associated with the β-cyclodextrin barrels was evident by the broad band centred around 3250 cm⁻¹.

### 2.2 Perfume Release

FIG. 4 shows infrared spectra of (a) the polymer layer derivatised with the 20 μM β-cyclodextrin solution; (b) vanillin; and (c) the derivatised polymer layer following its exposure to a 75 mM solution of vanillin.

It can be seen that the vanillin host-guest inclusion complexes formed with the β-cyclodextrin-derivatised pulsed plasma deposited poly(4-vinylbenzyl chloride) layers yielded two new prominent infrared absorbances appearing at 1665 cm⁻¹ (aldehyde C═O stretching) and 1587 cm⁻¹ (benzene ring C═C stretching) [55], which are signatures of the aldehyde and aromatic groups respectively contained in the vanillin molecule structure.

Quartz crystal microbalance measurements were used to track the capture of vapour phase vanillin molecules by the surface bound β-cyclodextrin barrels in real time. The results are shown in FIG. 5. Trace (a) was generated during vanillin exposure to the pulsed plasma deposited poly(4-vinylbenzyl chloride) layer (Pₚ=40 W; tₒₙ=100 μs; t_{off}=4 ms; 10 minutes), whilst trace (b) represents vanillin exposure to the 20 μM β-cyclodextrin derivatised pulsed plasma poly(4-vinylbenzyl chloride) layer (Pₚ=40 W; tₒₙ=100 μs; t_{off}=4 ms; 10 minutes).

The mass detected by the quartz crystal microbalance increased rapidly upon exposure of the surface tethered β-cyclodextrin barrels to vanillin, reaching saturation after approximately 55 seconds. Termination of the vanillin feed, followed by evacuation, produced a drop in mass reading correlating to a loss of vanillin molecules from the β-cyclodextrin barrels under vacuum. A theoretical mono layer coverage level of 5.65×10¹³ molecules cm⁻² can be calculated using a β-cyclodextrin surface area footprint of 1.77 nm^{2 [}56], with the barrel aligned vertical to the surface so as to facilitate host-guest molecule interactions (see FIG. 1). The quartz crystal microbalance measurements yield approximately 4.54×10¹³ vanillin molecules cm⁻² which equates to approximately an 80% surface coverage by cyclodextrin barrels. A second exposure to a vanillin feed recorded less than a 2% drop in their overall inclusion complex forming capability, thereby exemplifying the surface anchored β-cyclodextrins' recharging behaviour.

A control experiment using the underivatised pulsed plasma poly(4-vinylbenzyl chloride) layer displayed minimal interaction with the vanillin probe molecule, where a small rise in mass was detected which was lost upon evacuation (trace (a) in FIG. 5).

Further exemplification using an everyday substrate (non-woven polypropylene cloth) showed retention of high loading levels of vanillin over time (as measured by solvent extraction) when compared to a control underivatised pulsed plasma poly(4-vinylbenzyl chloride) layer coated onto a non-woven polypropylene cloth sample. The results are shown in FIG. 6, which charts vanillin release rates from a pulsed plasma poly(4-vinylbenzyl chloride) layer (Pₚ=40 W; tₒₙ=100 μs; t_{off}=4 ms; 10 minutes) deposited onto non-woven polypropylene cloth, both with and without β-cyclodextrin (CD) functionalisation. The release rates were measured using UV-Vis spectroscopy of solvent extracts.

It can be seen from FIG. 6 that despite comparable initial loadings, release rates for the control samples (82% after 2 weeks and 99% after 8 weeks) were much faster in comparison to the β-cyclodextrin-functionalised surfaces (5% after 2 weeks and 35% after 8 weeks).

### Example 2

### 1 Experimental

Inclusion complexes were prepared between (a) several well known essential oils (lavender, sandalwood, jasmine, rosemary, lemon and vanilla, The Body Shop Co Ltd) and (b) 20 μM β-cyclodextrin-functionalised pulsed plasma deposited poly(4-vinylbenzyl chloride) on non-woven polypropylene cloth, prepared as in Example 1. The complexes were made by exposing the functionalised polymer-coated cloth to a 75 mM ethanolic solution of the relevant oil for 72 hours. Subsequent washing with ethanol and propan-2-ol, followed by drying at 35° C. for 60 minutes, removed any unbound guest molecules. Essential oil guest molecule loading concentrations were calculated by extraction with an ethanol/water (50:50 v/v) mixture for 12 hours followed by UV-vis absorption spectroscopy measurement at a wavelength of 276 nm (absorption maxima for all essential oils studied) at regular time intervals.

Aroma activities of the freshly charged inclusion complexes were evaluated by sensory tests that entailed placing the functionalised non-woven polypropylene cloths in insulated booths stored at room temperature. They were nosed (i.e. smelt) at regular intervals in order to detect the scent. The levels of fragrance release from the inclusion complexes were compared with control samples comprising the underivatised pulsed plasma deposited poly(4-vinylbenzyl chloride) layer on non-woven polypropylene cloth. Both sets of aroma nosing assessments were undertaken by several individuals according to single-blinded experimental conditions [52] in which each insulated booth's scent was correctly identified before proceeding with scent intensity evaluation.

### 2 Results

This example further demonstrates the robustness and general applicability of β-cyclodextrin functionalised substrates in accordance with the invention.

The rates of release of the essential oils from the non-woven polypropylene cloths were monitored over a period of ten months. The results are shown in FIG. 7, which depicts the relative loadings of the six oils on the β-cyclodextrin derivatised polymer layer deposited onto non-woven polypropylene. The essential oils are labelled: (1) lavender; (2) sandalwood; (3) jasmine; (4) rosemary; (5) lemon; and (6) vanilla. For each oil, sequential vertical bars correspond to 0, 2, 4, 6, 8 and 10 months' storage in the open laboratory (20° C.).

It can be seen from FIG. 7 that the essential oil loadings diminish in a controlled manner, reaching approximately 81%±4% release after 10 months. In contrast, control experiments, in which the same essential oils were loaded onto underivatised pulsed plasma deposited poly(4-vinylbenzyl chloride) layers on non-woven polypropylene cloth, indicated approximately 82%±6% release after 2 weeks and 99%±1% after 2 months.

Table 2 below shows the results of the human sensorial evaluation performed with these essential oil-loaded β-cyclodextrin-derivatised polymer layers. The results, which reflect scent intensity emanating from the test substrates, indicated a lasting nose for 240 days (approximately 8 months).

In comparison, the control underivatised polymer layer (also deposited onto nonwoven polypropylene cloth) displayed no scent after 14 days. Recharging of the β-cyclodextrin-derivatised samples yielded no deterioration in human response over each subsequent 280 day trial period.

TABLE 2

| | Scent intensity/days | | | | | | | |
|---|---|---|---|---|---|---|---|---|
| Perfume | 10 | 40 | 80 | 120 | 160 | 200 | 240 | 280 |
| Laven- | +++++ | +++++ | ++++ | +++ | ++ | ++ | + | − |
| der | | | | | | | | |
| Sandal- | +++++ | +++++ | +++++ | ++++ | +++ | +++ | + | − |
| wood | | | | | | | | |
| Jasmine | +++++ | +++++ | +++++ | ++++ | +++ | ++ | ++ | − |
| Rose- | +++++ | +++++ | +++++ | ++++ | +++ | +++ | ++ | − |
| mary | | | | | | | | |
| Lemon | +++++ | +++++ | ++++ | +++ | ++ | + | + | − |
| Vanilla | +++++ | +++++ | +++++ | ++++ | +++ | +++ | ++ | − |

+++++ Very strong; ++++ Strong; +++ Common; ++ Weak; + Very weak; − None

### Discussion of Examples 1 and 2

These examples demonstrate that tethering of β-cyclodextrin barrels to pulsed plasma deposited poly(4-vinylbenzyl chloride) surfaces can be accomplished by the formation of ether linkages via the Williamson ether synthesis reaction [57]. In the presence of sodium hydroxide, the primary hydroxyl groups on β-cyclodextrin readily undergo an in situ conversion to alkoxide groups, which are then able to form ether linkages via nucleophilic substitution of chlorine centres contained in the polymer film (see FIGS. 1 and 3).

The high surface packing density of the 3-cyclodextrin barrels, inferred by the quartz crystal microbalance measurements (80% monolayer coverage), is indicative of the β-cyclodextrin barrels being suitably oriented both to accept and release guest molecules. This is probably a consequence of the overall inherent steric flexibility of the underlying polymeric linker layer, which can allow for a greater range of surface orientations to help maximise host-guest inclusion complex formation.

Previous attempts aimed at utilising chemisorbed β-cyclodextrin barrels (e.g. β-cyclodextrins chemically “fixed” to naturally occurring fabrics using linking agents such as triazinyl chloride, epichlorohydrin, or polycarboxylic acids) [63] are reported to display erratic perfume persistence for periods between 1 and 6 months [1, 5, 58]. In comparison, the invented surface tethered β-cyclodextrin barrels have been found to perform better at controlling volatile perfume molecule release even over a 10 month period (see FIGS. 6 and 7).

All of the essential oils contain lipophilic (fatty-type) alkane segments [59] which, like cholesterol (a lipid binding molecule), are capable of forming inclusion complexes inside the β-cyclodextrin cavities [60, 61]. The driving force towards complex formation is the displacement of high enthalpy polar-apolar interactions (e.g. between the apolar cyclodextrin cavity and polar water molecules initially solvated within the cyclodextrin) for apolar-apolar interactions (between the guest and the cyclodextrin cavity) [1] caused by the disruption and loss of water molecules. Subsequent slow release of guest molecules occurs as water molecules interpose the apolar-apolar interactions between guest and host over time [62], thereby leading to volatility of the guest molecule.

Active substance-loaded substrates according to the invention, which carry cyclodextrin-functionalised polymers such as those produced in Examples 1 and 2, can have a wide range of potential applications. By way of example only, β-cyclodextrin can be incorporated into shoe insoles to help in removing sweat so as to inhibit microbial growth and malodours [1, 5, 63]: the cyclodextrin could be supported on a substrate, and loaded with a perfume, in accordance with the invention, allowing the gradual release of perfume coincident with the removal of sweat. Other products, such as fabrics and articles made from them, could provide a “smart” dual-mechanism perfume release in a similar manner, with large guest perfume molecules being displaced by malodorous small molecules to assist in masking offensive smells. Such products could remain effective for several months, and if necessary could be “recharged” with perfume for subsequent re-use, for example during a cleaning process.

Furthermore by combining the inherent advantages of plasmachemical functionalisation (substrate independence, absence of solvents and low material wastage) with the ability to easily recharge tethered cyclodextrin barrels, the present invention can provide the potential for many more applications in the future involving controlled molecule release.

### REFERENCES

[1] Szejtli, J. J. Mater. Chem. 1997, 7, 575.
[2] Buschmann, H. J.; Knittek, D.; Schollermeyer, E. J. J. Incl. Phenom. Macro. 2001, 40, 169.
[3] Peppas, N. A.; Brannon-Peppas, L. J. Cont. Rel. 1996, 40, 245.
[4] Pena, B.; Casals, M.; Torras, C.; Gumi, T.; Garcia-Valls, R. Ind. Eng. Chem. Res. 2009, 48, 1562.
[5] Guan, J.; Chakrapani, A.; Hansford, D. J. Chem. Mater. 2005, 17, 6227.
[6] Nguyen, P. M.; Zacharia, N. S.; Verploegen, E.; Hammond, P. T. Chem. Mater. 2007, 19, 5524.
[7] Berthier, D. L.; Scmidt, I.; Fieber, W.; Schatz, C.; Furrer, A.; Wong, K.; Lecommandoux, S. B. Langmuir 2010, 26, 7953.
[8] Numano\check{g}lu, U.; Sen, T.; Tarimci, N.; Kartal, M.; Koo, O. M.; Onyüksel, H. AAPS Pharm. Sci. Tech. 2007, 8, E85.
[9] Destribats, M.; Schmitt, V.; Backov, R. Langmuir 2010, 26, 1734.
[10] Morinaga, H.; Morikawa, H.; Wang, Y.; Sudo, A.; Endo, T. Macromolecules 2009, 42, 2229.
[11] Li, S.; Purdy, W. C. Chem. Rev. 1992, 92, 1457.
[12] Szejtli, J. Cyclodextrin Technology; Kluwer Academic: Dordrecht, The Netherlands, 1988.
[13] Lach, J. L.; Chin, T.-F. J. Pharm. Sci. 1980, 19, 344.
[14] Park, C.; Kim, H.; Kim, S.; Kim, C. J. Am. Chem. Soc. 2009, 131, 16614.
[15] Ding, J.; Qin, W. J. Am. Chem. Soc. 2009, 131, 14640.
[16] Layre, A.; Volet, G.; Wintgens, V.; Amiel, C. Biomacromolecules 2009, 10, 3283.
[17] Leleivre, F.; Gareil, P.; Jardy, A. Anal. Chem. 1997, 69, 385.
[18] Ward, T. J. Anal. Chem. 2006, 78, 3947.
[19] Kano, K.; Kitagashi, H.; Tamura, S.; Yamada, A. J. Am. Chem. Soc. 2004, 126, 15210.
[20] Du, L.; Liao, S.; Khatib, H. A.; Stoddart, J. F.; Zink, J. I. J. Am. Chem. Soc. 2009, 131, 15136.
[21] Schlenk, H.; Sand, D. M. J. Am. Chem. Soc. 1961, 83, 2312.
[22] Cooper, A.; Nutley, M. A.; Camilleri, P. Anal. Chem. 1998, 70, 5024.
[23] Spies, M. A.; Schowen, R. L. J. Am. Chem. Soc. 2002, 124, 14049.
[24] Siegel, B.; Eberlein, D.; Rifkin, D.; Davis, K. A. J. Am. Chem. Soc. 1979, 101, 775.
[25] Hedges, A. R. Chem. Rev. 1998, 98, 2035.
[26] Uekama, K.; Hirayama, F.; Irie, T. Chem. Rev. 1998, 98, 2045.
[27] Odashima, K.; Kotato, M.; Sugaware, M.; Umezawa, Y. Anal. Chem. 1993, 65, 927.
[28] Lednev, I. K.; Petty, M. C. Adv. Mater. 1996, 8, 615.
[29] Auletta, T.; Dordi, B.; Mulder, A.; Sartori, A.; Onclin, S.; Bruinink, C. M.; Peter, M.; Nijhuis, C. A.; Beijleveld, H.; Schonherr, H.; Vancso, G. J.; Casnati, A.; Ungaro, R.; Ravoo, B. J.; Huskens, J.; Reinhoudt, D. N. Angew. Chem. Int. Ed. 2004, 43, 369.
[30] Crespo-Biel, O.; Dordi, B.; Reinhoudt, D. N.; Huskens, J. J. Am. Chem. Soc. 2005, 127, 7594.
[31] Liu, J.; Mendoza, S.; Roman, E.; Lynn, M.; Xu, R.; Kaifer, A. J. Am. Chem. Soc. 1999, 121, 4304.
[32] Michalke, A.; Janshoff, A.; Steinem, C.; Henke, C.; Steiber, M.; Galla, H.-J. Anal. Chem. 1999, 71, 2528.
[33] Cho, S. Y.; Allcock, H. R. Macromolecules 2009, 42, 4484.
[34] Arkas, M.; Allabashi, R.; Tsiourvas, D.; Mattausch, E.; Perfler, R.; Environ. Sci. Technol. 2006, 40, 2771.
[35] Schofield, W. C. E.; McGettrick, J. D.; Badyal, J. P. S. J. Phys. Chem. B. 2006, 110, 17161.
[36] Ryan, M. E.; Hynes, A. M.; Badyal, J. P. S. Chem. Mater. 1996, 8, 37.
[37] Hutton, S. J.; Crowther, J. M.; Badyal, J. P. S. Chem. Mater. 2000, 12, 2282.
[38] Tarducci, C.; Schofield, W. C. E.; Brewer, S. A.; Willis, C.; Badyal, J. P. S. Chem. Mater. 2001, 13, 1800.
[39] Tarducci, C.; Kinmond, E. J.; Brewer, S. A.; Willis, C.; Badyal, J. P. S. Chem. Mater. 2000, 12, 1884.
[40] Rinsch, C. L.; Chen, X. L.; Panchalingam, V.; Eberhart, R. C.; Wang, J. H.; Timmons, R. B. Langmuir 1996, 12, 2995.
[41] Tarducci, C.; Brewer, S. A.; Willis, C.; Badyal, J. P. S. Chem. Commun. 2005, 3, 406.
[42] Schofield, W. C. E.; McGettrick, J. D.; Bradley, T. J.; Przyborski, S.; Badyal, J. P. S. J. Am. Chem. Soc. 2006, 128, 2280.
[43] Harris, L. G.; Schofield, W. C. E.; Doores, K. J.; Davis, B. G.; Badyal, J. P. S. J. Am. Chem. Soc. 2009, 131, 7755.
[44] Coulson, S. R.; Woodward, I. S.; Brewer, S. A.; Willis, C.; Badyal, J. P. S. Chem. Mater. 2000, 12, 2031.
[45] Limb, S. J.; Gleason, K. K.; Edell, D. J.; Gleason, E. F. J. Vac. Sci. Technol. A 1997, 15, 1814.
[46] Wang, J. H.; Chen, J. J.; Timmons, R. B. Chem. Mater. 1996, 8, 2212.
[47] Mitchell, T. A.; Bode, J. W. J. Am. Chem. Soc. 2009, 131, 18057.
[48] Wierman, K. W., Hilfiker, J. N.; Woollam, J. A. Phys. Rev. B 1997, 55, 3093.
[49] Conny, J. M.; Powell, C. J. Surf. Interface Anal. 2000, 29, 856.
[50] Briggs, D.; Seah, M. P. Practical Surface Analysis, Vol 1: Auger and X-ray Photoelectron Spectroscopy; John Wiley: Chichester, UK, 1990.
[51] Prutton, M. Surface Physics; Oxford University Press: New York, 1985; p 23.
[52] Blank, R. M. The American Economic Review 1991, 81, 1041.
[53] Lin-Vien, D.; Colthrup, N. B.; Fateley, W. G.; Grasselli, J. G. The Handbook of Infrared and Raman Characteristic Frequencies of Organic Molecules; Academic Press: New York, 1991.
[54] Egyed, O. Vib. Spectrosc. 1990, 1, 225.
[55] Aubert, P. H.; Audebert, P.; Roche, M.; Capdevielle, P.; Maumy, M.; Ricart, G. Chem. Mater. 2001, 13, 2233.
[56] Yasuda, S.; Shigekawa, H.; Suzuki, I.; Nakamura, T.; Matsumoto, M.; Komiyami, M. Appl. Phys. Lett. 2000, 76, 643.
[57] Zhang, C.; Lilley, S. J.; Ainsworth, D.; Staunton, E.; Andreev, Y. G.; Slawin, A. M. Z.; Bruce, P. G. Chem. Mater. 2008, 20, 4039.
[58] D'Souza, V. T.; Lipkowitz, K. B. Chem. Rev. 1998, 98, 1741.
[59] Paili, A. Int. J. Essent. Oil Therapeut. 2008, 2, 60.
[60] Spizzirr, U. G.; Peppas, N. A. Chem. Mater. 2005, 17, 6719.
[61] Sellergren, B.; Wieschemeyer, J.; Boos, K.; Seidel, D. Chem. Mater. 1998, 10, 4037.
[62] Rekharsky, M. V.; Inoue, Y. Chem. Rev. 1998, 98, 1875.
[63] Szejtli, J. Starch 2003, 55, 191.

1. A delivery system for an active substance, the system comprising a substrate on which the active substance is loaded for subsequent release, wherein:
(i) the substrate has been coated, over at least a part of its surface, with a polymer, using plasma deposition;
(ii) the active substance is present as a guest molecule within a cyclodextrin inclusion complex; and
(iii) the cyclodextrin inclusion complex is bound to the polymer through a chemical linkage formed between a hydroxyl group on the cyclodextrin and a functional group on the polymer.

2. A delivery system according to claim 1, wherein the chemical linkage is formed between a primary hydroxyl group on the cyclodextrin and a functional group on the polymer.

3. A delivery system according to claim 1, wherein the chemical linkage is an ether linkage.

4. A delivery system according to claim 1, wherein the polymer has been applied to the substrate by pulsed plasma deposition.

5. A delivery system according to claim 1, wherein the polymer comprises an alkylating group, in particular a primary alkyl or aryl-alkyl halide, which is capable of reacting with a cyclodextrin hydroxyl group or nucleophilic derivative thereof.

6. A delivery system according to claim 1, wherein the active substance comprises a perfume, a lipophilic substance, or a substance having one or more lipophilic substituents.

7. A delivery system according to claim 1, wherein the cyclodextrin is a β-cyclodextrin.

8. A method for preparing a functionalized substrate on which an active substance can be loaded for subsequent release, the method comprising:
(i) providing a substrate which has been coated, over at least a part of its surface, with a polymer, using plasma deposition; and
(ii) reacting the polymer with a cyclodextrin so as to generate a chemical linkage between a hydroxyl group on the cyclodextrin and a functional group on the polymer.

9. A method according to claim 8, wherein the reaction step (ii) is an SN2 nucleophilic substitution reaction, in particular a Williamson ether synthesis reaction.

10. A method according to claim 8, which also comprises applying the polymer to the substrate prior to the reaction step (ii), using plasma deposition.

11. A functionalized substrate coated with a polymer, over at least a part of its surface, using plasma deposition, and in which the polymer is bound to a cyclodextrin molecule via a chemical linkage formed between a hydroxyl group on the cyclodextrin and a functional group on the polymer.

12. A method comprising: (i) capturing a first active substance from a first environment containing it by introducing into the first environment a functionalized substrate according to claim 11, and allowing the first active substance to enter a cyclodextrin molecule as a guest molecule; or (ii) preparing an active substance delivery system by loading an active substance onto a functionalized substrate according claim 11, so as to generate an active substance-containing cyclodextrin inclusion complex attached to the polymer.

13. The method of claim 12, comprising loading an active substance onto a functionalized substrate according claim 11, so as to generate an active substance-containing cyclodextrin inclusion complex attached to the polymer.

14. The functionalized substrate according to claim 11, wherein the functionalized substrate forms or is incorporated into a product.

15. The method of claim 12, wherein the release of an active substance from the substrate is controlled.
